(19) United States
(12) Patent Application Publication
(10) Pub. No.: US 2006/0190841 A1
(43) Pub. Date: Aug. 24, 2006

(54) Display apparatus and control method thereof

(75) Inventor: Jeong-yeon Lee, Uijeongbu-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd., Suwon-si (KR)

(21) Appl. No.: 11/288,075

(22) Filed: Nov. 29, 2005

(30) Foreign Application Priority Data
Feb. 22, 2005 (KR) 2005-0014661

(51) Int. Cl. G06F 9/00

(52) U.S. Cl. 715/810; 715/835; 715/856; 715/862

(57) ABSTRACT

The present invention relates to a method of controlling a display apparatus having a user input part to manipulate a user control menu including at least one control item. The method involves displaying the user control menu in a halftone when a user control function is selected via the user input part, and increasing a display tone of the control item by a predetermined level, which is pointed to on the user control menu via the user input part. Thus, the present invention provides a display apparatus and a control method thereof, in which a user can clearly recognize what selection is performed in a halftone user control menu.

### PRIORITY

This application claims the benefit under 35 U.S.C. §119(a) of Korean Patent Application No. 2005-0014661, filed Feb. 22, 2005, in the Korean Intellectual Property Office, the entire contents of which are incorporated herein by reference.

### BACKGROUND OF THE INVENTION

1. Field of the Invention

The present invention relates to a display apparatus and a control method thereof. More particularly, the present invention relates to a display apparatus and a control method thereof in which a user can clearly recognize what selection is made in a halftone user control menu.

2. Description of the Related Art

Generally, a display apparatus such as a television, a monitor, a plasma display panel (PDP) apparatus, and so on comprises a display part on which a picture is displayed, a signal processor to process an input video signal and convert the processed video signal to be displayed on the display part, and a microcomputer to control the display part and the signal processor.

In such a display apparatus, a user control menu having various control items is displayed as an on screen display (OSD) for allowing a user to control the states of the display apparatus. Thus, a user can control the states of the display apparatus by viewing and selecting from the user control menu.

Meanwhile, there has recently been proposed a display apparatus that displays the user control menu as a halftone OSD. Here, the halftone OSD is obtained by lowering the display tone of the general OSD, and displayed overlapping with a background displayed on the display part, so that a user can see the background through the translucent user control menu.

However, in the conventional display apparatus supporting the halftone OSD, the user control menu is seen dimly, and therefore it is difficult for a user to distinguish a selected item from the other items of the user control menu. Thus, a user is likely to make a mistake in controlling the states of the display apparatus.

### SUMMARY OF THE INVENTION

Accordingly, it is an object of the present invention to provide a display apparatus and a control method thereof in which a user can clearly recognize what selection is made in a halftone user control menu.

Additional exemplary aspects and/or advantages of the invention will be set forth in part in the description which follows and, in part, will be obvious from the description, or may be learned by practice of the invention.

The foregoing and/or other exemplary aspects of the present invention are achieved by a method of controlling a display apparatus comprising a user input part to manipulate a user control menu having at least one control item. The method comprises displaying the user control menu in a halftone when a user control function is selected via the user input part, and increasing a display tone of the control item by a predetermined level, which is pointed to on the user control menu via the user input part.

According to an exemplary aspect of the present invention, the method further comprises displaying a sub-control menu in a halftone when the pointed control item is selected, wherein the sub-control menu comprises a plurality of sub-control items corresponding to the pointed control item.

According to an exemplary aspect of the present invention, the method further comprises increasing a display tone of the sub-control item by a predetermined level, which is pointed to on the sub-control menu via the user input part, and implementing a function corresponding to the pointed sub-control item when the sub-control item is pointed at via the user input.

According to an exemplary aspect of the present invention, the method further comprises moving a pointing highlight to go farther beyond the sub-control item by a predetermined distance in a moving direction and then moving again to substantially exactly point to the sub-control item when the pointing highlight is moved to the sub-control items to be pointed to on the sub-control menu in correspondence with manipulation of the user input part.

According to an exemplary aspect of the present invention, the sub-control items displayed on the sub-control menu comprise a video and sound control item to control a video mode and a sound mode, an image size control item to adjust the size of an image, a language control item to select a language, an input control item to select an input video source, and an automatic program item to search information about tunable channels.

According to an exemplary aspect of the present invention, the method further comprises moving a pointing highlight to go farther beyond the control item by a predetermined distance in a moving direction and then moving again to substantially exactly point to the control item when the pointing highlight is moved to the control items to be pointed to on the user control menu in correspondence with manipulation of the user input part.

According to an exemplary aspect of the present invention, the displaying of the sub-control menu comprises closing the user control menu, and displaying the sub-control menu in the halftone, the sub-control menu comprising a plurality of sub-control items corresponding to the selected control item.

According to an exemplary aspect of the present invention, the pointing to the control item on the user control menu comprises moving a pointing highlight on the user control menu in correspondence with upper, lower, left and right key manipulations of the user input part.

According to an exemplary aspect of the present invention, the pointing to the control item on the user control menu comprises displaying a stationary pointing highlight on the user control menu, moving the control items in correspondence with upper, lower, left and right key manipulations of the user input part, and pointing to one control item by the stationary pointing highlight as the control items are moved.

According to an exemplary aspect of the present invention, the pointing to the control item on the user control menu comprises expanding the pointing highlight by a predetermined size when the control items are moved.

According to an exemplary aspect of the present invention, the pointing to the control item on the user control menu comprises lowering the display tone of the pointing highlight by a predetermined level when the control items are moved.

According to an exemplary aspect of the present invention, the control items of the user control menu are horizontally arranged in a predetermined area of the whole screen of a display apparatus, and move leftward/rightward in correspondence with the left/right key manipulation of the user input part, and the control item, which moves beyond one of left and right sides of the whole screen and disappears as the control items are moved leftward/rightward, is displayed to reappear at the other sides.

According to an exemplary aspect of the present invention, the user input part comprises a menu key to select the user control menu, (−) and (+) keys to point to the control items and the sub-control items, an enter key to select the pointed control item, and an exit key.

According to an exemplary aspect of the present invention, the control items of the user control menu are horizontally arranged in a predetermined area of the whole screen of a display apparatus, and move leftward/rightward in correspondence with the left/right key manipulation of the user input part, and the control item, which moves beyond one of left and right sides of the whole screen and disappears as the control items are moved leftward/rightward, is displayed to reappear at the other sides.

According to an exemplary aspect of the present invention, the user input part comprises a menu key to select the user control menu, (−) and (+) keys to point to the control items and the sub-control items, an enter key to select the pointed control item, and an exit key.

The foregoing and/or other exemplary aspects of the present invention are achieved by providing a display apparatus comprising an OSD generator to generate an OSD signal to display a user control menu having at least one control item in a halftone, a user input part to manipulate the user control menu, and a controller to control the OSD generator to display the user control menu when a user control function is selected via the user input part, and increase a display tone of the control item by a predetermined level, the control item being pointed to by manipulation of the user input part.

### BRIEF DESCRIPTION OF THE DRAWINGS

These and other aspects and advantages of the present invention will become apparent and more readily appreciated from the following description of the exemplary embodiments, taken in conjunction with the accompany drawings of which:

FIG. 1 is a control block diagram of a display apparatus according to an exemplary embodiment of the present invention;

FIG. 2 is a control flowchart of the display apparatus according to an exemplary embodiment of the present invention;

FIG. 3 is a control flowchart of changing a pointing highlight while moving a control item in the display apparatus according to an exemplary embodiment of the present invention;

FIG. 4 is a control flowchart of providing a visual effect of elasticity to the pointing highlight for sub-control items while moving the pointing highlight in the display apparatus according to an exemplary embodiment of the present invention;

FIG. 5 illustrates that the control item is pointed to in the display apparatus according to a first embodiment of the present invention;

FIGS. 6A, 6B and 6C illustrate that the control item is pointed to in the display apparatus according to a second embodiment of the present invention;

FIGS. 7A and 7B illustrate that the pointing highlight is changed while the control item is pointed to in the display apparatus according to the second embodiment of the present invention;

FIGS. 8A, 8B and 8C illustrate respective sub-control menus in the display apparatus according to an exemplary embodiment of the present invention; and

FIG. 9 illustrates the visual effect of elasticity for the pointing highlight while moving the pointing highlight on the sub-control menu, e.g., an image size control menu shown in 8-2 of FIG. 8A, according to an exemplary embodiment of the present invention.

Throughout the drawings, the same or similar elements are denoted by the same reference numerals.

### DETAILED DESCRIPTION-OF THE. EXEMPLARY EMBODIMENTS

Reference will now be made in detail to the exemplary embodiments of the present invention, examples of which are illustrated in the accompanying drawings.

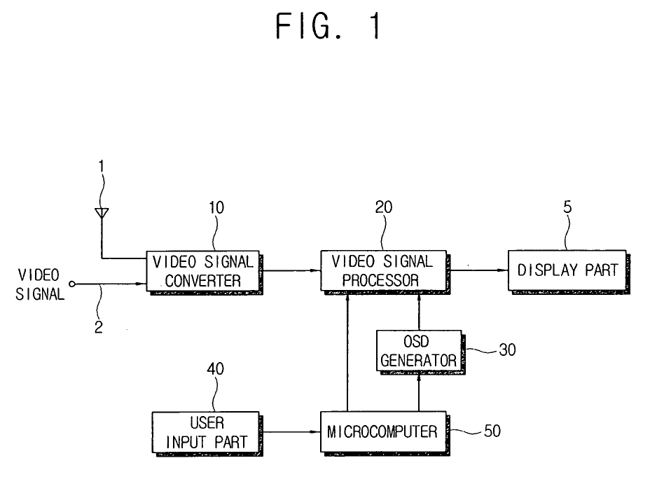

As shown in FIG. 1, a display apparatus according to an exemplary embodiment of the present invention comprises a display part 5, a video signal converter 10, a video signal processor 20, an OSD generator 30, a user input part 40 and a microcomputer 50.

The display part 5 receives a video signal from the video signal processor 20 and displays a picture based on the received video signal. The display part 5 comprises a display panel (not shown) on which a picture is displayed, and a panel driver (not shown) to process the video signal received from the video signal processor 20 and drive the display panel to display a picture thereon.

The video signal converter 10 converts an input video signal to be processed by the video signal processor 20. Here, the video signal converter 10 comprises a tuner (not shown) to receive a radio frequency (RF) broadcasting signal through an antenna 1 and output the RF broadcasting signal, and a video decoder (not shown) to decode an analog video signal 2 such as a composite video baseband signal (CVBS), an S-video signal, and so on, which is received through a connection terminal (not shown), or the broadcasting signal outputted from the tuner. The video decoder then outputs the decoded video signal to the video signal processor 20.

Further, the video signal converter 10 can comprise a transition minimized differential signaling (TMDS) receiver to divide a digital video signal such as a digital video interface (DVI) signal received from an external source through a digital connection terminal (not shown) into a red/green/blue (RGB) digital signal and a horizontal/vertical (H/V) synchronous signal, and to output the RGB digital signal and the H/V synchronous signal to the video signal processor 20 and the video signal converter 10 can also comprise an analog/digital (A/D) converter (not shown) to convert an analog video signal such as a component signal, a personal computer signal or the like into the digital video signal, and to output the digital video signal to the video signal processor 20.

The video signal processor 20 processes the input video signal to be displayed as a picture on the display part 5. Here, the video signal processor 20 is controlled by the microcomputer 50 to process a picture based on the video signal outputted from the video signal converter 10 to be displayed on the display part 5, and a predetermined menu based on an OSD menu signal outputted from the OSD generator 30 to be superposed on the picture and displayed on the display part 5.

The user input part 40 outputs a key signal to the microcomputer 50 according to a user's manipulation. The user input part 40 comprises a menu key (not shown) to select a user control function, a left key (−) and a right key (+) provided in a front of the display apparatus, an enter key (not shown), an exit key (not shown), and a key signal generator (not shown) to generate a key signal corresponding to key manipulation. Further, the user input part 40 can comprise a separate input unit such as a mouse (not shown), a keyboard (not shown), and a wireless remote controller (not shown). When a user manipulates a button or a key, the key signal generator generates the key signal corresponding to the key manipulation and outputs the key signal to the microcomputer 50. Thus, the microcomputer 50 controls the video signal processor 20, the OSD generator 30, and so on in correspondence with the key signal received from the key signal generator.

The OSD generator 30 provides the display part 5 with an OSD user control menu having one or more control items to control the states of the display apparatus, and an OSD submenu corresponding to each control item. Here, the OSD menu signals generated from the OSD generator 30 in correspondence with the OSD user control menu and the OSD submenu are added to the video signal outputted from the video signal processor 20, and then displayed on the display part 5.

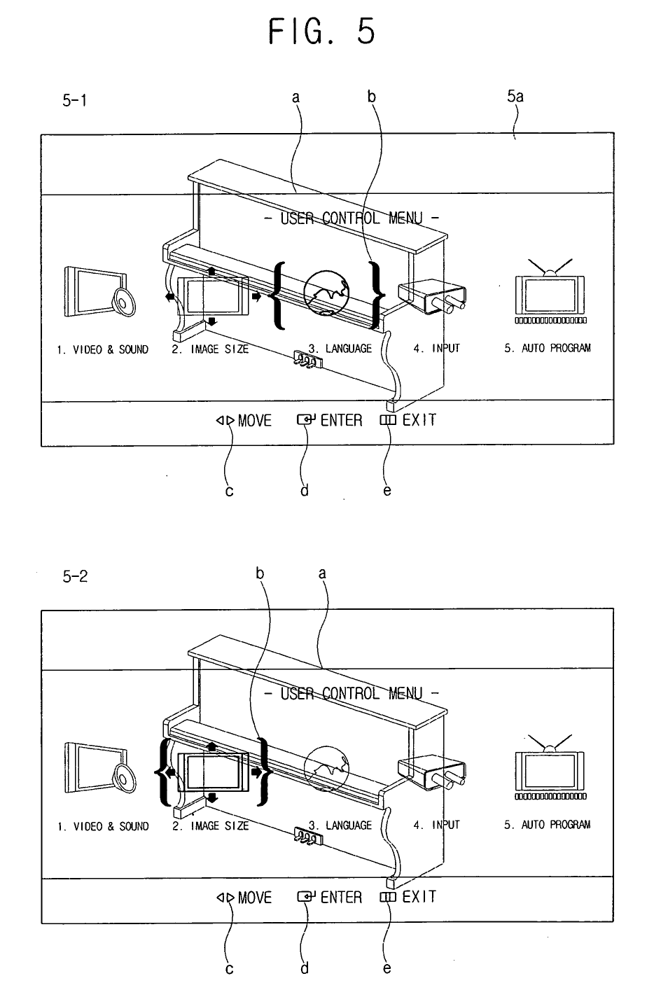

At this time, the OSD generator 30 supports a halftone OSD. As shown in FIG. 5, the display tone of an OSD user control menu a is lowered, and thus the OSD user control menu a is superposed on a background 5a displayed on the display part 5. Hence, both the OSD user control menu a and the background 5a are seen by a user. Meanwhile, the OSD generator 30 increases the display tone of a control item (e.g., 3. language) that is currently activated by control of the microcomputer 50. Thus, the control item (e.g., 3. language) pointed to by a user is highlighted as compared with the other control items. Here, the display tone of the pointed control item can be increased enough to essentially cover the background 5a.

When a pointing highlight is moved to point to the control item or the sub-control item, the OSD generator 30 is controlled by the microcomputer 50 to move the pointing highlight to a desired control item or a desired sub-control item farther beyond the desired control item or the desired sub-control item by a predetermined distance and then substantially exactly move the pointing highlight to the control item or the sub-control item on the basis of the control of the microcomputer 50. That is, when a user moves the pointing highlight toward a desired item in order to point to the item, the pointing highlight temporarily goes farther beyond the desired item and then returns to the desired item essentially exactly. It seems therefore as if the pointing highlight is temporarily moved farther in a moving direction by the law of inertia and elastically returned to the item, thereby providing a user with a visual effect of elasticity.

Herein below, a method of pointing to the control item through the OSD user control menu according to a first embodiment of the present invention will be described with reference to FIG. 5. The OSD generator 30 moves the pointing highlight b on the OSD user control menu a. That is, when a signal corresponding to the left key (−) of the user input part 40 is inputted (e.g., interlocking with a moving item c of the OSD user control menu a) such that the control item of “3. LANGUAGE” is pointed to (refer to 5-1 of FIG. 5), the microcomputer 50 controls the OSD generator 30 to move the pointing highlight b leftward and point to the control item of “2. IMAGE SIZE” (refer to 5-2 of FIG. 5). Correspondingly, the OSD generator 30 increases the display tone of the control item of “2. IMAGE SIZE”, pointed to by the pointing highlight b.

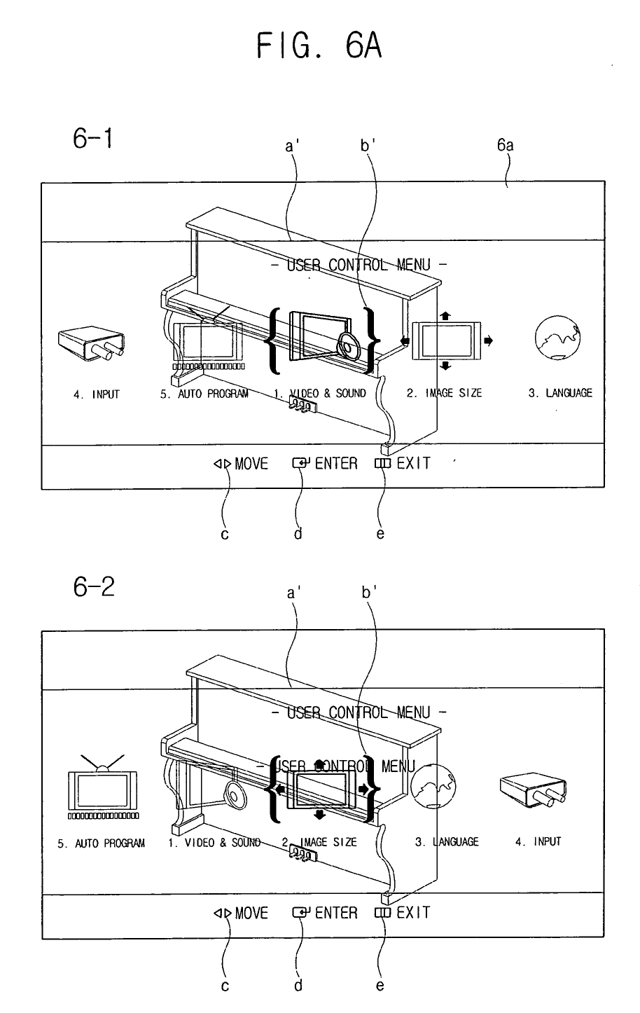

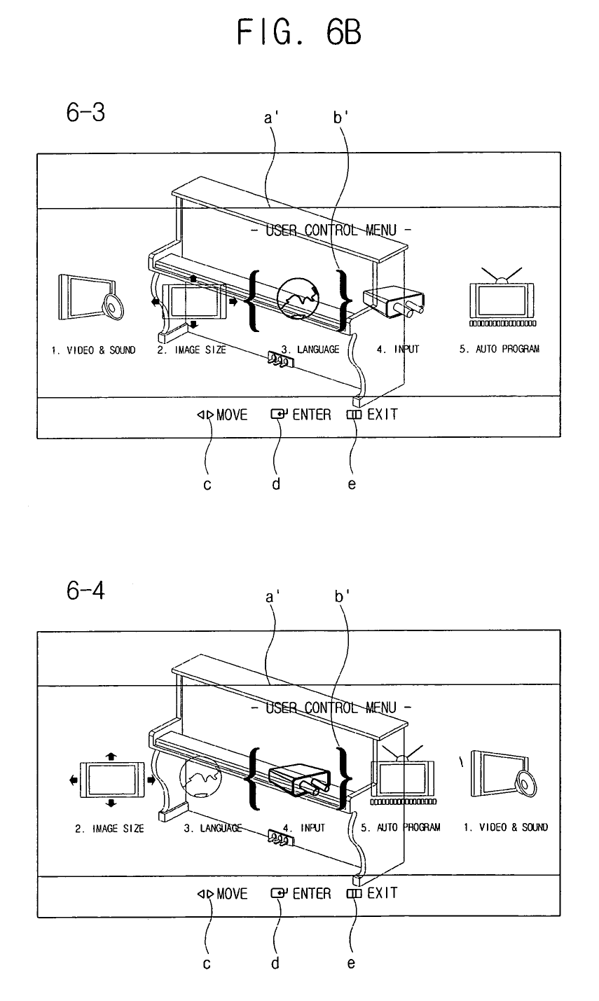

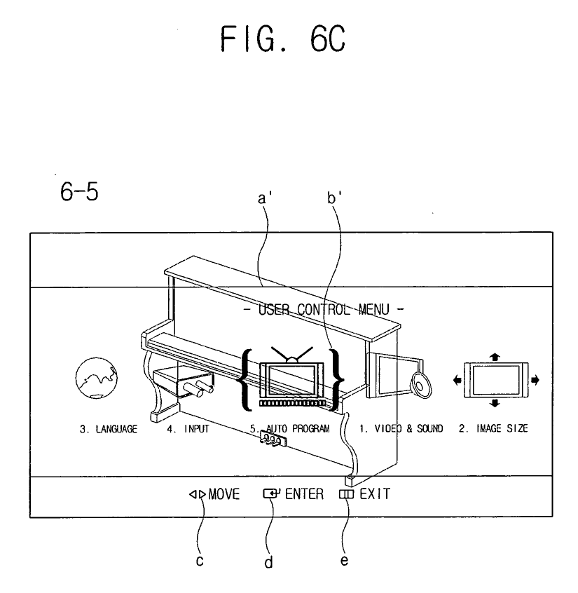

According to a second embodiment of the present invention, the control item can be pointed to on the OSD user control menu as shown in FIGS. 6A-6C. That is, the OSD generator 30 moves the control items with respect to a stationary pointing highlight b′ on an OSD user control menu a′ displayed as a halftone OSD overlapping with the background 6a.

When a signal corresponding to the right key (+) of the user input part 40 is inputted (e.g., interlocking with the moving item c of the OSD user control menu a′) such that the control item of “1. VIDEO & SOUND” is pointed to (refer to 6-1 of FIG. 6A), the OSD generator 30 moves the control items leftward. Then, as shown in 6-2 of the FIG. 6A, the stationary pointing highlight b′ points to the control item of “2. IMAGE SIZE” which is placed on the right hand of the control item of “1. VIDEO & SOUND” before the right key (+) is manipulated. Correspondingly, the OSD generator 30 increases the display tone of the pointed control item of “2. IMAGE SIZE”. On the other hand, when a signal corresponding to the left key (−) of the user input part 40 is inputted such that the control item of “2. IMAGE SIZE” is pointed to (refer to 6-2 of FIG. 6A), the control items are moved rightward, thereby pointing to the control item of “1. IMAGE & SOUND” (refer to 6-1 of FIG. 6A).

Thus, the control items are moved on the OSD user control menu a′ as the left key (−) and the right key (+) are manipulated, the control items of “3. LANGUAGE” (refer to 6-3 of FIG. 6B), “4. INPUT” (refer to 6-4 of FIG. 6B) and “5. AUTOMATIC PROGRAM” (refer to 6-5 of FIG. 6C) can be pointed to.

The microcomputer 50 controls the OSD generator 30 to display the OSD user control menu as the halftone OSD when a user control function is selected via the menu key of the user input part 40. Further, the microcomputer 50 controls the OSD generator 30 to point to the control item in accordance with how the left key (−) and the right key (+) are manipulated using the user input part 40.

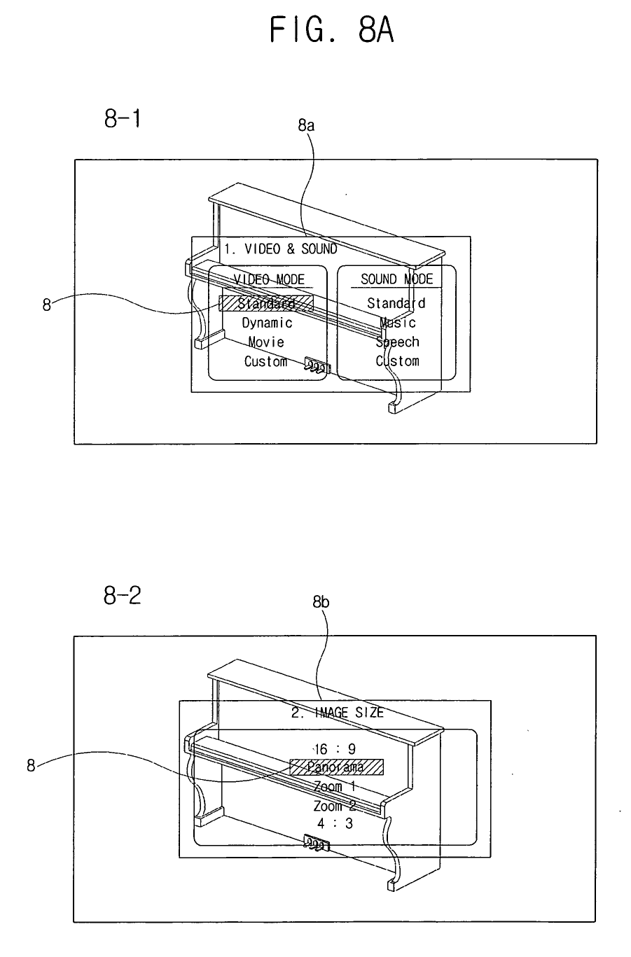

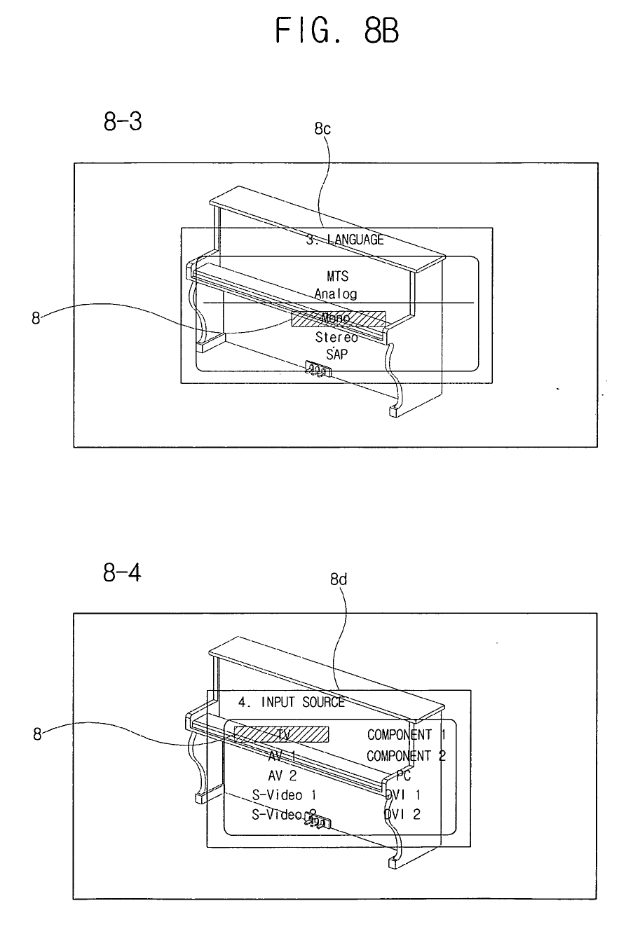

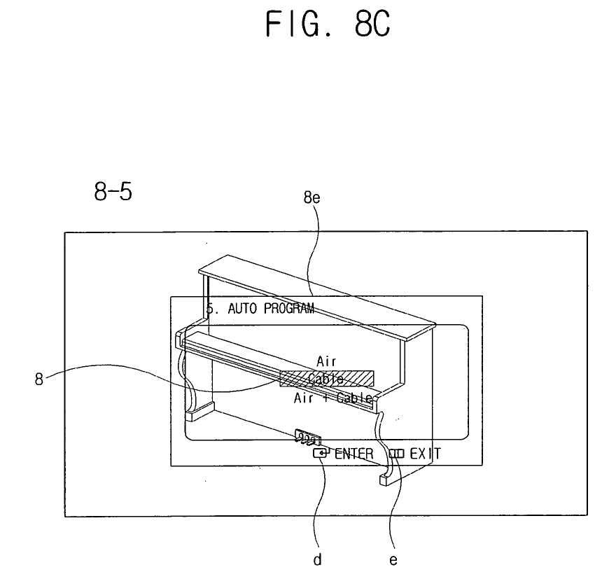

Here, the microcomputer 50 controls the OSD generator 30 to display an OSD sub-control menu (refer to 8-1 of FIG. 8A) corresponding to the pointed control item (e.g., “1. VIDEO & SOUND) when the enter key (not shown) of the user input part 40 is inputted (e.g., interlocking with an enter item d of the OSD user control menu a′) as indicated at 6-1 in FIG. 6A. Here, in order to point to a sub-control item of the OSD sub-control menu 8a corresponding to the control item of “1. VIDEO & SOUND”, either the pointing highlight 8 or the sub-control items can be moved as the left key (−) and the right key (+) are manipulated by a user.

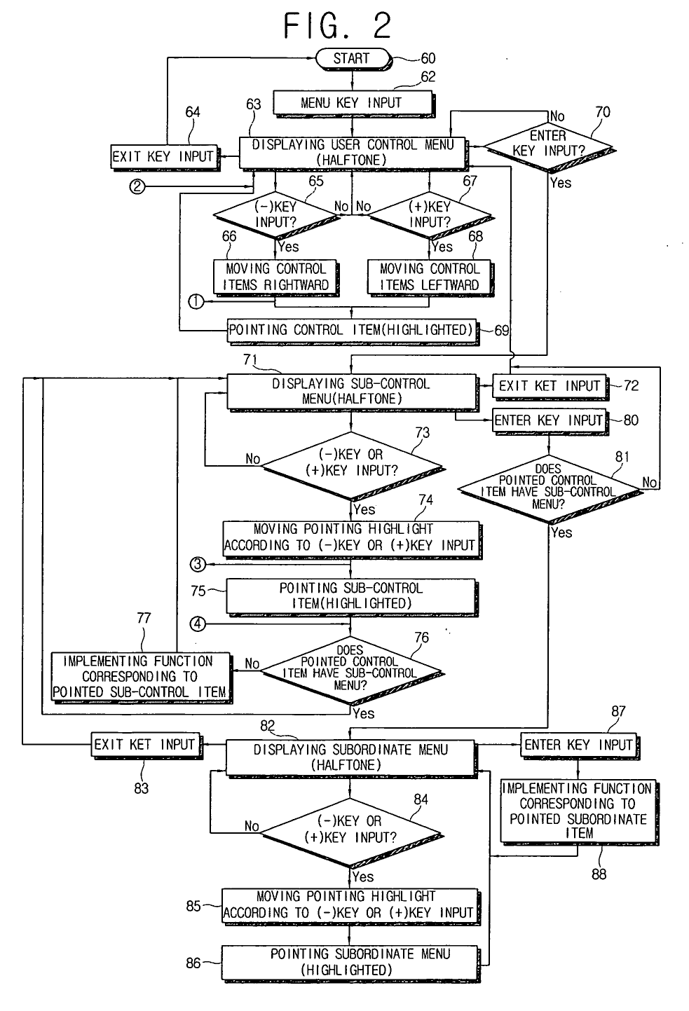

Herein below, the control flow of the display apparatus according to an exemplary embodiment of the present invention will be described with reference to FIGS. 2 through 4. Here, the flowchart of FIG. 2 is illustrated on the assumption that a subordinate menu of the sub-control menu is the lowest sub-menu.

At operation 62, a signal corresponding to the menu key of the user input part 40 is inputted to the display apparatus. At operation 63, the microcomputer 50 controls the OSD generator 30 to display the OSD user control menu. At this time, the OSD generator 30 displays the OSD user control menu as the halftone OSD. At operation 64, when a signal corresponding to the exit key is inputted to the display apparatus, the microcomputer 50 controls the OSD generator 30 to close the OSD user control menu and returns to the starting operation 60. At operation 65, the left key (−) of the user input part 40 is inputted. At operation 66, the OSD generator 30 moves the control items rightward on the OSD user control menu. On the other hand, at operation 67, the right key (+) of the user input part 40 is inputted. At operation 68, the OSD generator 30 moves the control items leftward on the OSD user control menu. As the control items are moves leftward/rightward, at operation 69, a desired control item is pointed to by the stationary highlight. At this time, the OSD generator 30 displays the pointed control item to be highlighted as compared with the other control items. Therefore, a user can clearly recognize what control item is pointed to while controlling the states of the display apparatus through the OSD user control menu displayed as the halftone OSD.

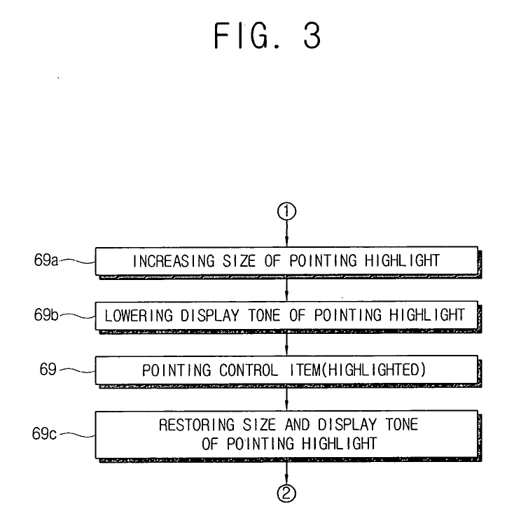

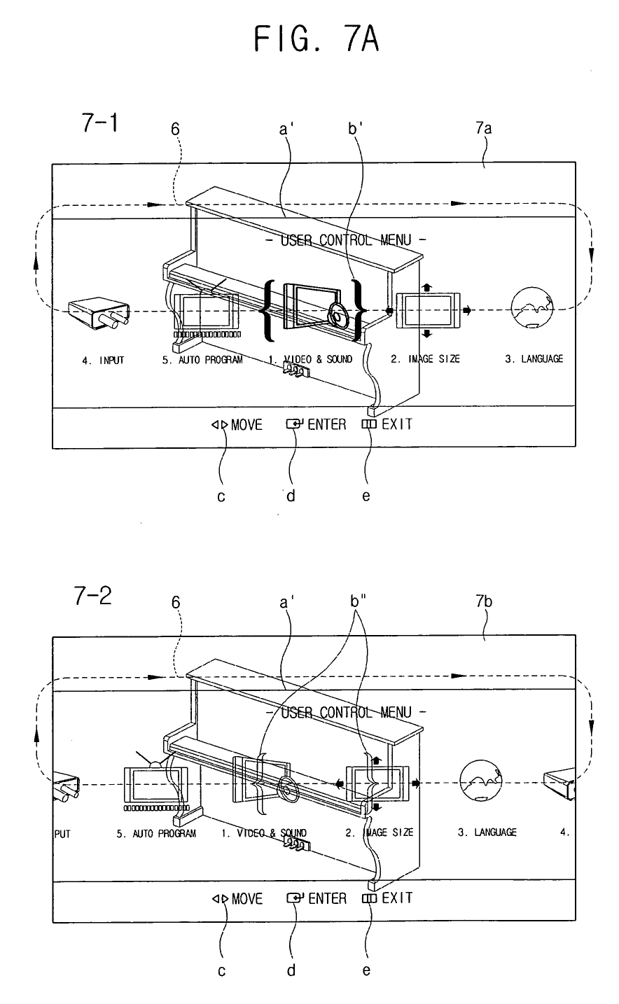

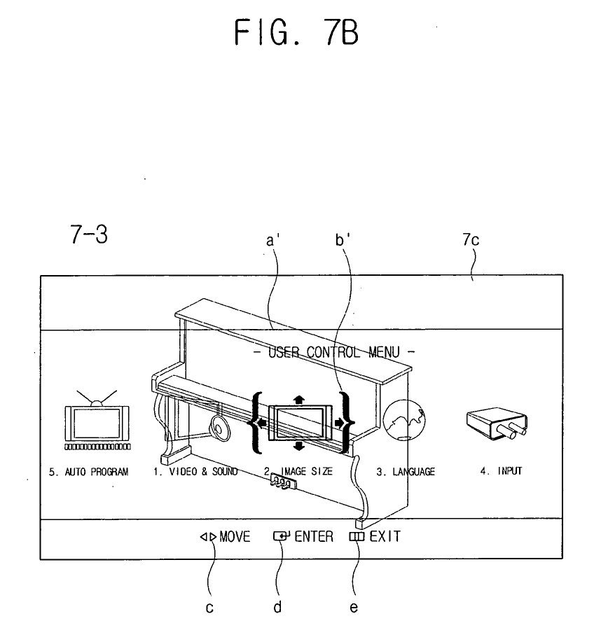

Further, the detailed control flow of the display apparatus will be described with reference to FIGS. 3, 7A and 7B. At operation 62, a signal corresponding to the menu key is inputted to the display apparatus. At operation 63, the OSD user control menu a′ is displayed as the halftone OSD (refer to 7-1 of FIG. 7A). At this time, the OSD user control menu a′ displays the latest pointed control item (e.g., “1. VIDEO & SOUND”, refer to 6-1 of FIG. 6A). Further, the control item of “1. VIDEO & SOUND” and the pointing highlight b′ are highlighted as compared with the other control items. Then, at operation 67, a signal corresponding to the right key (+) is inputted to the display apparatus. At operation 68, the control items are moved leftward. While the control items are moved, at operation 69a, (i.e., entering \textcircled{1} step of FIG. 3, refer to 7-2 of FIG. 7A), the pointing highlight b″ is seen to be expanded. At operation 69b, the display tone of the pointing highlight b” is decreased and seen dimly. At operation 69, the display tone of the control item of “2. IMAGE SIZE” is increased and highlighted as shown in 7-3 of FIG. 7B when the control items have stopped moving. At operation 69c, the size and the display tone of the pointing highlight b″ return to the original size and the original display tone. After the operation 69c (i.e., \textcircled{2} step), the control flow returns to the operation 63 in FIG. 2.

In the meantime, there is provided a visual effect that the control items are seen to move along a virtual moving line 6 as shown in FIG. 7A. That is, as the control items are moved, the control item of “4. INPUT” (refer to 7-1 of FIG. 7A) disappears (refer to 7-2 of FIG. 7A) and is then displayed next to the control item of “3. LANGUAGE” (refer to 7-3 of FIG. 7B). Thus, the control items are seen as if they rotate while the control items are moved leftward. Likewise, the same visual effect is applied while the control items are moved rightward. Hence, the control items are efficiently disposed and shown to a user. Alternatively, the control items, which are frequently selected by a user, may be preferentially displayed on the display part 5, thereby allowing a user to easily select the control items.

In the operation 63 of FIG. 2 whereby the control item is pointed to on the OSD user control menu, at operation 70, the enter key is inputted to the display apparatus. Then, at operation 71, the microcomputer 50 controls the OSD generator 30 to display the OSD sub-control menu corresponding to the pointed control item. Prior to describing the control flow following the operation 71, the OSD sub-control menu corresponding to each control item will be described with reference to FIGS. 8A-8C.

8-1 of FIG. 8A shows the OSD sub-control menu corresponding to the control item 8a of “1. VIDEO & SOUND”. The sub-control menu 8a of “1. VIDEO & SOUND” comprises the sub-control items for adjusting a video mode, and the sub-control items for adjusting a sound mode. Thus, a user can select an optimum video mode and an optimum sound mode in consideration of both the video and the sound. 8-2 of FIG. 8A shows the OSD sub-control menu corresponding to the control item of “2. IMAGE SIZE”. The sub-control menu 8b of “2. IMAGE SIZE” comprises the sub-control items for adjusting the size of an image. 8-3 of FIG. 8B shows the OSD sub-control menu corresponding to the control item of “3. LANGUAGE”. The sub-control menu 8c of “3. LANGUAGE” comprises the sub-control items for selecting the language. 8-4 of FIG. 8B shows the OSD sub-control menu corresponding to the control item of “4. INPUT”. The sub-control menu 8d of “4. INPUT” comprises the sub-control items for selecting a video signal source. 8-5 of FIG. 8C shows the OSD sub-control menu corresponding to the control item of “5. AUTOMATIC PROGRAM”. The sub-control menu 8e of “5. AUTOMATIC PROGRAM” comprises the sub-control items for searching information about tunable channels. In each sub-control menu, the pointing highlight 8 moves among the sub-control items in accordance with how the left key (−) and the right key (+) are manipulated.

Regarding the operation 71, at operation 72, a signal corresponding to the exit key is inputted to the display apparatus. Then, the microcomputer 50 controls the OSD generator 30 to close the OSD sub-control menu and return to the operation 63 of displaying the OSD user control menu. At operation 73, the left key (−) and/or the right key (+) of the user input part 40 are manipulated. Then, at operation 74, the pointing highlight is moved in correspondence with the manipulation of the left key (−) and/or the right key (+). At operation 75, a desired sub-control item is pointed to in correspondence with the manipulation of the left key (−)/the right key (+). Here, the OSD generator 30 increases the display tone of the pointed sub-control item to be highlighted as compared with the other sub-control items. At operation 76, the microcomputer 50 determines whether the pointed sub-control item has subordinate menus. When the pointed sub-control item does not have the subordinate menus, at operation 77, the microcomputer 50 implements the pointed sub-control item and returns to the operation 71. That is, the pointed sub-control item is directly implemented by just pointing to the sub-control item without a separate selection input. For example, in the case of the sub-control menu 8b of “2. IMAGE SIZE”, there is no need for selecting, checking a predetermined image size, and then returning to selecting and checking another image size. The size of an image is converted into the size corresponding to the pointed sub-control item and displayed when the sub-control item is just selected. As an example of the sub-control menus for directly implementing the pointed sub-control item, there are the sub-control menu 8a of “1. VIDEO & SOUND”, the sub-control menu 8b of “2. IMAGE SIZE”, the sub-control menu 8c of “3. LANGUAGE”, and the sub-control menu 8d of “4. INPUT”.

On the other hand, when it is determined that the pointed sub-control item has the subordinate menus in the operation 76, at operation 71, the pointed sub-control menu is displayed, pending a separate key input. Preferably, the sub-control menu having the subordinate menu is the sub-control menu 8e of “5. AUTOMATIC PROGRAM”.

While the sub-control menu including the pointed sub-control item is displayed in the operation 71, at operation 80, the enter key is inputted. Then, at operation 81, the microcomputer 50 determines whether the pointed sub-control item has the subordinate menu. When it is determined that there is no subordinate menu corresponding to the pointed sub-control item in the operation 81, the microcomputer 50 returns to the operation 63. On the other hand, when it is determined that there is the subordinate menu corresponding to the pointed sub-control item in the operation 81, the microcomputer 50 controls the OSD generator 30 to display the OSD subordinate-control menu corresponding to the pointed sub-control item.

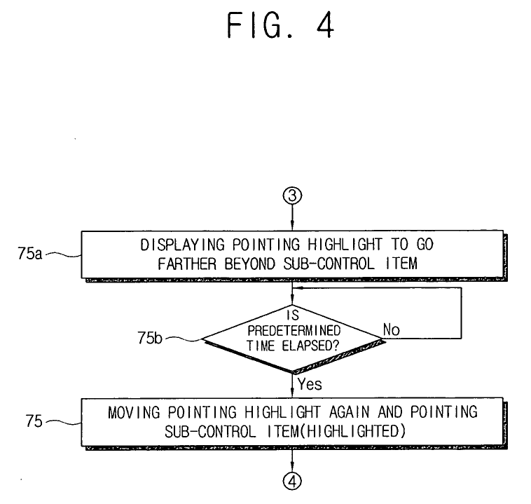

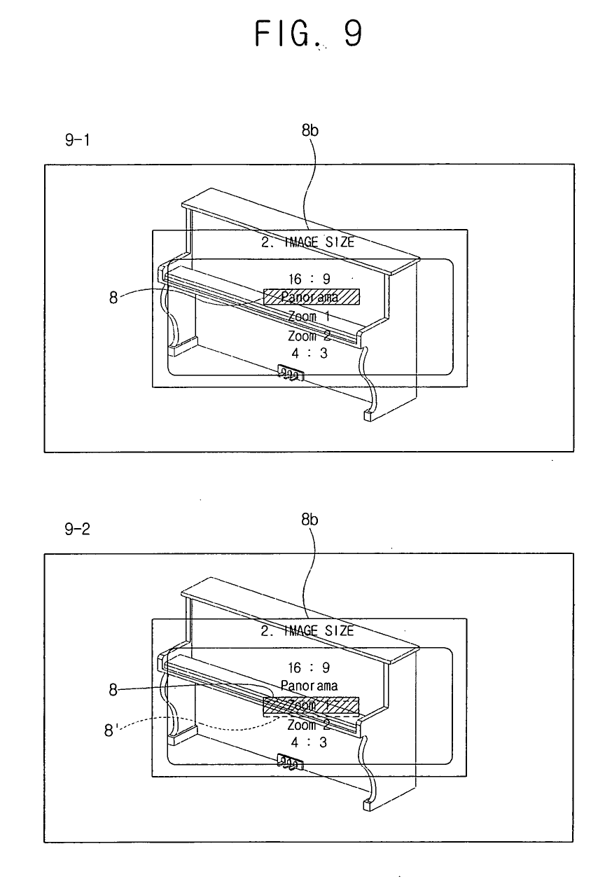

Herein below, moving operations of the pointing highlight for pointing to the sub-control item on the OSD sub-control menu will be described with reference to FIGS. 4 and 9. At operation 73, the signal corresponding to the left key (−) is inputted to the display apparatus in the state that the sub-control menu 8b of “2. IMAGE SIZE” including a sub-control item of “PANORAMA” pointed to by the pointing highlight 8 is displayed as shown in 9-1 of FIG. 9 in the operation 71. Then, at operation 74, the pointing highlight 8 moves to the next sub-control item of “ZOOM1”. While the pointing highlight 8 moves to the sub-control item of “ZOOM1” in the operation 74, at operation 75a in FIG. 4 (\textcircled{3} step), the visual effect of elasticity makes the pointing highlight 8 go farther beyond the sub-control item of “ZOOM1” by a predetermined distance, thereby pointing to the sub-control item of “ZOOM1” with the pointing highlight 8′ passing beyond the sub-control item of “ZOOM1”. Thus, the pointing highlight 8′ passes beyond the sub-control item of “ZOOM1” as shown in 9-2 of FIG. 9. After a lapse of a predetermined time at operation 75b in FIG. 4, the pointing highlight 8′ is moved again, and at operation 75, the pointing highlight 8 is displayed for essentially exactly pointing to the sub-control item of “ZOOM1.”. Then, the microcomputer 50 enters the operation 76 through \textcircled{4} step. Here, the elapsed time is relatively short, so that the pointing highlight temporarily goes farther beyond the desired sub-control item and then returns to the desired sub-control item exactly. That is, it seems as if the pointing highlight is temporarily farther moved in a moving direction by the law of inertia and elastically returned to the sub-control item, thereby providing a user with the visual effect of elasticity.

Following the operation 82 in FIG. 2, at operation 83, the signal corresponding to the exit key is inputted to the display apparatus. Then, the microcomputer 50 controls the OSD generator 30 to close the OSD subordinate menu of the OSD sub control menu and return to the operation 71 of displaying the OSD sub-control menu. At operation 84, the left key (−) and/or the right key (+) of the user input part 40 are manipulated on the OSD subordinate menu. Then, at operation 85, the pointing highlight is moved in correspondence with the manipulation of the left key (−)/the right key (+). At operation 86, a desired subordinate item of the OSD subordinate menu is pointed to in correspondence with the manipulation of the left key (−)/the right key (+). Here, the OSD generator 30 increases the display tone of the pointed subordinate item to be highlighted as compared with the other subordinate items. Further, the visual effect of elasticity can be provided while the pointing highlight is moved on the subordinate menu. Thereafter, at operation 87, the signal corresponding to the enter key is inputted to the display apparatus. Then, at operation 88, the microcomputer 50 implements the pointed subordinate item.

Thus, various visual effects are given to a user while a user controls the states of the display apparatus through the halftone OSD user control menu, so that a user can clearly recognize what control item is pointed to by him/her.

According to an embodiment of the present invention, the display apparatus displays the user control menu as the halftone OSD, and visually differentiates the pointed control item from the other control items so as to make a user clearly distinguish the pointed control item from the other control items on the halftone user control menu, thereby allowing a user to recognize what control item is pointed to by him/her.

As described above, the present invention provides a display apparatus and a control method thereof, in which a user can clearly recognize what selection is performed in a halftone user control menu.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling a display apparatus comprising a user input part to manipulate a user control menu including at least one control item, the method comprising:
displaying the user control menu in a halftone when a user control function is selected via the user input part; and
increasing a display tone of the control item by a predetermined level, which is pointed to on the user control menu via the user input part.

2. The method according to claim 1, further comprising displaying a sub-control menu in a halftone when the pointed control item is selected, wherein the sub-control menu comprises a plurality of sub-control items corresponding to the pointed control item.

3. The method according to claim 2, further comprising:
increasing a display tone of the sub-control item by a predetermined level, which is pointed to on the sub-control menu via the user input part; and
implementing a function corresponding to the pointed sub-control item when the sub-control item is pointed to.

4. The method according to claim 3, further comprising moving a pointing highlight to go farther beyond the sub-control item by a predetermined distance in a moving direction and then moving again to substantially exactly point to the sub-control item when the pointing highlight is moved to the sub-control items to be pointed to on the sub-control menu in correspondence with a manipulation of the user input part.

5. The method according to claim 4, wherein the sub-control items displayed on the sub-control menu comprise a video and sound control item to control a video mode and a sound mode, an image size control item to adjust the size of an image, a language control item to select a language, an input control item to select an input video source, and an automatic program item to search information about tunable channels.

6. The method according to claim 5, further comprising moving a pointing highlight to go farther beyond the control item by a predetermined distance in a moving direction and then moving again to substantially exactly point to the control item when the pointing highlight is moved to the control items to be pointed to on the user control menu in correspondence with a manipulation of the user input part.

7. The method according to claim 6, wherein the displaying of the sub-control menu comprises closing the user control menu, and displaying the sub-control menu in the halftone, the sub-control menu comprising a plurality of sub-control items corresponding to the selected control item.

8. The method according to claim 7, wherein the pointing to the control item on the user control menu comprises moving a pointing highlight on the user control menu in correspondence with upper, lower, left and right key manipulations of the user input part.

9. The method according to claim 7, wherein the pointing to the control item on the user control menu comprises:
displaying a stationary pointing highlight on the user control menu;
moving the control items in correspondence with upper, lower, left and right key manipulations of the user input part; and
pointing one control item by the stationary pointing highlight as the control items are moved.

10. The method according to claim 9, wherein the pointing to the control item on the user control menu comprises expanding the pointing highlight by a predetermined size when the control items are moved.

11. The method according to claim 10, wherein the pointing to the control item on the user control menu comprises lowering the display tone of the pointing highlight by a predetermined level when the control items are moved.

12. The method according to claim 11, wherein the control items of the user control menu are horizontally arranged in a predetermined area of the whole screen of a display apparatus, and move leftward/rightward in correspondence with the left/right key manipulation of the user input part, and
the control item, which moves beyond one of left and right sides of the whole screen and disappears as the control items are moved leftward/rightward, is displayed to reappear at the other sides.

13. The method according to claim 12, wherein the user input part comprises a menu key to select the user control menu, (−) and (+) keys to point to the control items and the sub-control items, an enter key to select the pointed control item, and an exit key.

14. The method according to claim 1, wherein the pointing to the control item on the user control menu comprises moving a pointing highlight on the user control menu in correspondence with upper, lower, left and right key manipulations of the user input part.

15. The method according to claim 1, wherein the pointing to the control item on the user control menu comprises:
displaying a stationary pointing highlight on the user control menu;
moving the control items in correspondence with upper, lower, left and right key manipulations of the user input part; and
pointing one control item by the stationary pointing highlight as the control items are moved.

16. The method according to claim 15, wherein the pointing to the control item on the user control menu comprises expanding the pointing highlight by a predetermined size when the control items are moved.

17. The method according to claim 16, wherein the pointing to the control item on the user control menu comprises lowering the display tone of the pointing highlight by a predetermined level when the control items are moved.

18. The method according to claim 17, wherein the control items of the user control menu are horizontally arranged in a predetermined area of the whole screen of a display apparatus, and move leftward/rightward in correspondence with the left/right key manipulation of the user input part, and
the control item, which moves beyond one of left and right sides of the whole screen and disappears as the control items are moved leftward/rightward, is displayed to reappear at the other sides.

19. The method according to claim 18, wherein the user input part comprises a menu key to select the user control menu, (−) and (+) keys to point to the control items and the sub-control items, an enter key to select the pointed control item, and an exit key.

20. A display apparatus comprising:
an OSD generator to generate an OSD signal to display a user control menu including at least one control item in a halftone;
a user input part to manipulate the user control menu; and
a controller to control the OSD generator to display the user control menu when a user control function is selected via the user input part, and increase a display tone of the control item by a predetermined level, the control item being pointed to by manipulation of the user input part.
